(19) United States
(12) Patent Application Publication
(10) Pub. No.: US 2005/0107565 A1
(43) Pub. Date: May 19, 2005

(54) Polyisocyanates with biuret structure, blocked with secondary amines

(75) Inventors: Christoph Thiebes, Koln (DE); Reinhard Halpaap, Odenthal (DE); Beate Baumbach, Burscheid (DE); Dieter Mager, Leverkusen (DE); Christian Fussel, Tonisvorst (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 10/966,792

(22) Filed: Oct. 15, 2004

(30) Foreign Application Priority Data
Oct. 17, 2003 (DE) 10348380.2

(51) Int. Cl. C08G 18/00

(52) U.S. Cl. 528/44

(57) ABSTRACT

Storage-stable blocked polyisocyanates prepared by reacting one or more polyisocyanates with one or more biuretizing agents and optionally, catalysts such that in the blocked end product there are 5-45 equivalent percent of biuret groups according to formula (I) 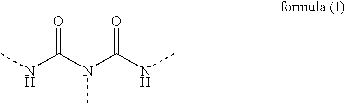
based on the sum total of all free and blocked NCO groups; optionally modifying the resulting biuret polyisocyanates with the aid of isocyanate-reactive compounds and/or catalysts, with further reaction of free NCO groups; and subsequently blocking at least 95 mol percent of the remaining free NCO groups with a blocking agent according to the formula R¹R²NH, where R¹ and R² independently of one another are aliphatic or cycloaliphatic C₁-C₁₂ alkyl radicals. The blocked polyisocyanates can be used to make polyurethane polymers and coating compositions, which can be used to coat substrates.

### CROSS REFERENCE TO RELATED PATENT APPLICATION

The present patent application claims the right of priority under 35 U.S.C. §119 (a)-(d) of German Patent Application No.103 48 380.2, filed Oct. 17, 2003.

### BACKGROUND OF THE INVENTION

1. Field of the Invention

The present invention relates to new storage-stable blocked polyisocyanates based on linear aliphatic diisocyanates, to a process for preparing them and to their use for producing coatings.

2. Description of the Prior Art

Blocked polyisocyanates are used for example in one-component polyurethane (1K PU) baking enamels, particularly in automotive OEM finishing, for the coating of plastics and for coil coating.

The blocking of polyisocyanates has long been common knowledge for applications including the preparation of crosslinker components for 1K polyurethane coating systems.

EP-A 0 096 210 discloses diisocyanates and polyisocyanates blocked with secondary amines and their use in solvent-borne 1K PU baking enamels. These blocking agents have the advantage over others that they react with polyhydroxyl compounds even at relatively low temperatures and are therefore also suitable for use in coating compositions for heat-sensitive substrates such as plastics. Starting polyisocyanates mentioned include isocyanurates and uretdiones, but not biurets based on aliphatic and cycloaliphatic diisocyanates.

As is known from EP-A 0 600 314, however, organic solutions of diisopropylamine-blocked polyisocyanates with isocyanurate structure based on linear aliphatic diisocyanates, for example those of hexamethylene diisocyanate, are not storable over months, since they have a very high tendency to solidify as a result, for example, of crystallization of the blocked polyisocyanate they contain. Consequently they are unsuitable for use in solvent-borne 1K PU coating systems.

In special cases it is possible to obtain blocked polyisocyanates whose solutions in organic solvents do not tend towards solidification as a result, for example, of crystallization, through the use of two or more different blocking agents (so-called mixed blocking) (cf. e.g. EP-A 0 600 314, EP-A 0 654 490). As compared with the use of a single blocking agent, however, mixed blocking always represents an increased cost and inconvenience in the preparation of the blocked polyisocyanates. Furthermore, the coating properties may be affected in a particularly adverse way by the blocking agent mixture released, and so polyisocyanates with mixed blocking are not suitable for general use.

In accordance with the teaching of DE-OS 197 38 497 diisopropylamine-blocked polyisocyanates stable to crystallization can be obtained if a mixture of polyisocyanates synthesized from linear aliphatic diisocyanates and polyisocyanates synthesized from cycloaliphatic diisocyanates is modified with hydroxy-functional hydrazide compounds, with partial reaction of some NCO groups, and blocked with diisopropylamine. Coating films produced from these polyisocyanates, however, have a markedly different profile of properties from those based purely on linear aliphatic diisocyanates. For instance, the addition of cycloaliphatic polyisocyanates to 1K and 2K polyurethane coating materials generally lowers the scratch resistance, which is important for automotive clearcoating, for example, and reduces the flexibility of the coatings which is necessary for coil coating. Accordingly mixtures of blocked linear aliphatic and cycloaliphatic polyisocyanates are not suitable for general use in those sectors.

WO 03/025040 teaches the preparation of polyisocyanates containing biuret groups on the basis of hexamethylene diisocyanate, the polyisocyanates containing not only biuret groups but also iminooxadiazinedione or isocyanurate groups. It is mentioned that these polyisocyanates can be blocked with customary blocking agents such as alcohols, oximes, ketimines and the like, although amines are not mentioned in that context.

The object of the present invention was to provide new polyisocyanates blocked with secondary amines and based on linear aliphatic diisocyanates, the organic solutions of which polyisocyanates possess long-term stability and even after months do not tend towards solidification as a result, for example, of crystallization.

### SUMMARY OF THE INVENTION

The present invention is directed to a process for preparing blocked polyisocyanates, including reacting one or more polyisocyanates with one or more biuretizing agents and optionally, catalysts such that in the blocked end product there are 5-45 equivalent percent of biuret groups according to formula (I) 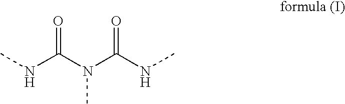
based on the sum total of all free and blocked NCO groups; optionally modifying the resulting biuret polyisocyanates with the aid of isocyanate-reactive compounds and/or catalysts, with further reaction of free NCO groups; and subsequently blocking at least 95 mol percent of the remaining free NCO groups with a blocking agent according to the formula R¹R²NH, where R¹ and R² independently of one another are aliphatic or cycloaliphatic C₁-C₁₂ alkyl radicals.

The present invention is also directed to blocked polyisocyanates obtained by the above-described process, coating compositions produced by combining the blocked polyisocyanates and one or more NCO-reactive binders containing on average at least two isocyanate-reactive groups per molecule, as well as polyurethane polymers obtained by reacting the blocked polyisocyanates with one or more NCO-reactive binders containing on average at least two isocyanate-reactive groups per molecule.

The present invention is further directed to one-component baking systems that include a) one or more of the above-described blocked polyisocyanates, b) one or more NCO-reactive binders containing on average at least two isocyanate-reactive groups per molecule, c) optionally catalysts and d) optionally solvents, auxiliaries and additives.

The present invention is additionally directed to coatings obtained by combining the above-described blocked polyisocyanates and dihydroxyl compounds and/or polyhydroxyl compounds, as well as to substrates coated with any of the above-described coatings and/or coating compositions.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

It has now been found that special biuret polyisocyanates blocked with secondary amines and based on aliphatic diisocyanates when blocked are storage-stable in the form of their organic solutions and do not tend towards solidification as a result, for example, of crystallization.

The invention accordingly provides a process for preparing blocked polyisocyanates which comprises
A) reacting one or more polyisocyanates with
B) one or more biuretizing agents and
C) if desired, catalysts such that in the blocked end product there are 5-45 equivalent% of biuret groups of the formula (I) 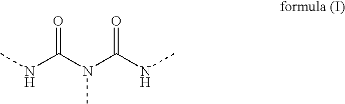
   based on the sum total of all free and blocked NCO groups,
D) if desired, modifying the resulting biuret polyisocyanates with the aid of isocyanate-reactive compounds and/or catalysts, with further reaction of free NCO groups, and subsequently
E) blocking at least 95 mol % of the remaining free NCO groups with a blocking agent of the formula R¹R²NH, in which R¹ and R² independently of one another are aliphatic or cycloaliphatic C₁-C₁₂ alkyl radicals.

The invention further provides the blocked polyisocyanates thus obtainable in accordance with the invention.

Suitable compounds of the polyisocyanate component A) include in principle all linear aliphatic diisocyanates, which may be used individually or in any desired mixtures with one another. By way of example these are 1,4-diisocyanatobutane, 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane or 1,10-diisocyanatodecane.

In addition it is also possible in A) to use all of the higher molecular weight polyisocyanates which are based on the abovementioned diisocyanates and have isocyanurate, uretdione, iminooxadiazinedione, oxadiazinetrione, urethane, allophanate and/or carbodiimide structures. These polyisocyanates and their modes of preparation are described for example in J. Prakt. Chem. 336 (1994) pp. 185-200.

Preference is given to using in A) HDI and/or HDI-based polyisocyanates of the aforementioned kind.

Suitable biuretizing agents in component B) and suitable optional catalysts in C) include in principle all of the compounds known to the person skilled in the art such as are described for example in J. Prakt. Chem. 336 (1994) pp. 185-200, EP-A 0 157 088 and EP-A 0 716 080.

Suitable biuretizing agents in B) include for example water and also substances which give off water under the reaction conditions of biuretization, such as acid anhydrides, tertiary alcohols and substances containing water of crystallization. A further possibility is to use diamines as biuretizing agents, these compounds initially reacting with the NCO groups of the isocyanates to form ureas and thereafter reacting further with further NCO groups to form biuret groups. A preferred biuretizing agent used is water.

The amount of biuret groups and the amount of biuretizing agent needed to prepare them can be calculated by methods known to the person skilled in the art. The consumption of the NCO groups by the biuretization reaction can be determined, for example, by way of the change in the NCO content over the duration of the biuretization reaction.

It is possible to use a catalyst C) for accelerating the biuretization reaction. Examples of those suitable include acids, preferably α,α,α-substituted acetic acid derivatives, particular preference being given to hydroxypivalic acid and pivalic acid.

If the biurets thus obtained are to be modified further, they can be reacted with or without addition of catalyst with (further) NCO groups or NCO-reactive groups to form urethane, allophanate, uretdione, carbodiimide, iminooxadiazinedione and/or isocyanurate structures. Examples of suitable catalysts include organic and inorganic bases, such as tertiary amines, potassium hydroxide, quaternary ammonium hydroxides, ammonium fluorides, ammonium carboxylates or metal salts such as tin compounds, zinc compounds and bismuth compounds, for example.

In the course of the modification the formation of uretdione and/or isocyanurate may come about, for example, through reaction of NCO groups of the biurets with one another. It is also possible to add further diisocyanates or polyisocyanates, which then form the stated oligomeric structures with the biurets by way of free NCO groups.

As NCO-reactive groups for the modification it is possible to use, for example, low or high molecular weight, difunctional or polyfunctional alcohols, amines or the conventional high molecular weight polyhydroxyl compounds based on polyester, polyether, polycarbonate or polyacrylate.

Proportionally it is also possible to use NCO-reactive monofunctional compounds which in addition to that functionality also have one or more further functional groups such as carboxylic acid groups or acrylate groups.

The reaction conditions for the modification are known from polyurethane chemistry and are therefore familiar to the person skilled in the art.

Blocking agents of the formula R¹R²NH used in E) are preferably diisopropylamine, N,N-tert-butylbenzylamine, dicyclohexylamine or mixtures of these compounds; with particular preference diisopropylamine exclusively is used.

The blocking reaction takes place in accordance with methods known to the person skilled in the art, by direct reaction of the remaining free NCO groups with the blocking agent in a molar ratio of from 0.95 to 1.5, preferably from 0.98 to 1.05, in particular 1:1.

The process of the invention can be carried out if desired in a suitable solvent which is inert towards isocyanate groups. Examples of suitable solvents include the conventional paint solvents, such as ethyl acetate, butyl acetate, 1-methoxy-2-propyl acetate, 3-methoxy-n-butyl acetate, acetone, 2-butanone, 4-methyl-2-pentanone, cyclohexanone, toluene, xylene, N-methylpyrrolidone and chlorobenzene. Mixtures which in particular contain aromatics with relatively high levels of substitution, such as are on the market, for example, under the names Solvent Naphtha, Solvesso® (Exxon Chemicals, Houston, USA), Cypar® (Shell Chemicals, Eschborn, DE), Cyclo Sole (Shell Chemicals, Eschborn, DE), Tolu Sol® (Shell Chemicals, Eschborn, DE) and Shellsol® (Shell Chemicals, Eschborn, DE), are likewise suitable.

Alternatively the solvents can be added following the preparation of the blocked polyisocyanates of the invention, in order to lower the viscosity for example. In this case it is also possible to use alcohols, such as isobutyl alcohol, since in that case the NCO groups present have reacted completely with isocyanate-reactive groups of the blocking agent E).

Preferred solvents are acetone, butyl acetate, 2-butanone, 1-methoxy-2-propyl acetate, xylene, toluene, isobutyl alcohol, mixtures containing primarily aromatics with relatively high levels of substitution, such as are on the market, for example, under the names Solvent Naphtha, Solvesso® (Exxon Chemicals, Houston, USA), Cypar® (Shell Chemicals, Eschborn, DE), Cyclo Solo (Shell Chemicals, Eschborn, DE), Tolu Sole (Shell Chemicals, Eschborn, DE) and Shellsol® (Shell Chemicals, Eschborn, DE).

In the process of the invention or in the products obtainable accordingly it is possible if desired to add auxiliaries or additives. Examples of these are antioxidants such as 2,6-di-tert-butyl-4-methylphenol, UV absorbers of the 2-hydroxyphenylbenzotriazole type or light stabilizers of the type of the HALS compounds unsubstituted or substituted on the nitrogen atom, such as Tinuvin® 292 and Tinuvin® 770 DF (Ciba Spezialitäten GmbH, Lampertheim, DE) or other commercially customary stabilizers, such as are described, for example, in “Lichtschutzmittel für Lacke” (A. Valet, Vincentz Verlag, Hannover, 1996 and “Stabilization of Polymeric Materials” (H. Zweifel, Springer Verlag, Berlin, 1997, Appendix 3, pp. 181-213), or any desired mixtures of these compounds. In addition it is also possible to use stabilizers containing hydrazide groups and/or hydroxy-functional stabilizers such as the adduct of hydrazine with propylene carbonate that is described in EP-A 0 829 500.

The blocked polyisocyanates of the invention form clear solutions in the stated solvents and contain 5-45 equivalent % of biuret groups corresponding to the formula (I) 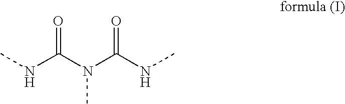
based on the sum total of the equivalents of blocked and non-blocked isocyanate groups in the polyisocyanate in question, with at least 95% and preferably 99% of the isocyanate groups being in blocked form.

The blocked polyisocyanates of the invention can be used as a constituent in solvent-borne or aqueous coating materials or for producing polyurethane materials. In particular they can be used as a crosslinker component in 1K baking enamels, especially for the coating of plastics, for automotive OEM finishing or for coil coating.

Accordingly the invention further provides one-component baking systems comprising
a) one or more blocked polyisocyanates obtainable in accordance with the invention,
b) one or more NCO-reactive binders containing on average at least two isocyanate-reactive groups per molecule,
c) optionally catalysts and
d) optionally solvents, auxiliaries and additives.

The invention further provides substrates coated with the one-component baking systems of the invention.

For preparing the one-component baking systems (1K baking enamels) essential to the invention the polyisocyanates a) of the invention are mixed with the film-forming binders b) known per se in coatings technology, with or without the admixture of further constituents c) and d), such as solvents and other auxiliaries and additives, such as plasticizers, flow assistants, pigments, fillers, or catalysts which accelerate the crosslinking reaction. It should be ensured that mixing is carried out below the temperature at which the blocked NCO groups are able to react with the other constituents. Mixing takes place preferably at temperatures between 15 and 100° C.

The compounds used as film-forming binders b) in the 1K baking enamels, and which are crosslinked with the compositions of the invention, contain on average at least 2 NCO-reactive groups per molecule, such as hydroxyl, mercapto, unsubstituted or substituted amino or carboxylic acid groups.

The film-forming binders b) used are preferably dihydroxyl and polyhydroxyl compounds, such as polyhydroxy polyesters, polyhydroxy polyethers or other hydroxyl-containing polymers, examples being the conventional polyhydroxy polyacrylates having a hydroxyl number of from 20 to 200 mg KOH/g, preferably from 50 to 130 mg KOH/g, this figure being based on products in 100% by weight form, or polyhydroxy carbonates or polyhydroxy urethanes.

Examples of suitable polyester polyols are in particular the reaction products, conventional in polyurethane chemistry, of polyhydric alcohols, for example alkane polyols such as neopentyl glycol, ethylene glycol, 1,2- and/or 1,3-propanediol, 1,2- and/or 1,3- and/or 1,4-butanediol, trimethylolpropane, glycerol, pentaerythritol, 1,5-pentanediol and 1,6-hexanediol, with substoichiometric amounts of polycarboxylic acids and/or polycarboxylic anhydrides, especially dicarboxylic acids and/or dicarboxylic anhydrides. Suitable polycarboxylic acids or polycarboxylic anhydrides are, for example, suberic acid, oxalic acid, succinic acid, itaconic acid, pimelic acid, azelaic acid, adipic acid, phthalic acid, isophthalic acid, tetrahydrophthalic acid, hexahydrophthalic acid, maleic acid, their Diels-Alder adducts with cyclopentadiene, fumaric acid or dimeric and/or trimeric fatty acids, and the anhydrides of the stated acids. In the preparation of the polyester polyols it is of course possible to use any desired mixtures of the exemplified polyhydric alcohols or any desired mixtures of the exemplified acids and/or acid anhydrides. The polyester polyols have for example a number-average molecular weight of from 500 to 10 000 g/mol, preferably from 800 to 5000 g/mol, more preferably from 1000 to 3000 g/mol.

The polyester polyols are prepared in accordance with known methods, as described for example in Houben-Weyl, Methoden der organischen Chemie, volume XIV/2, G. Thieme-Verlag, 1963, pages 1 to 47. Any hydrophilic modification to these polyhydroxyl compounds that may be necessary takes place in accordance with methods known per se, as described for example in EP-A- 157 291 or EP-A-427 028.

Suitable polyether polyols are the ethoxylation and/or propoxylation products, known per se from polyurethane chemistry, of suitable difunctional to tetrafunctional starter molecules such as water, ethylene glycol, propanediol, trimethylolpropane, glycerol and/or pentaerythritol, for example.

The polyhydroxyl polyacrylates are conventional copolymers of styrene with simple esters of acrylic acid and/or methacrylic acid, the hydroxyl groups being introduced by using hydroxyalkyl esters, such as the 2-hydroxyethyl, 2-hydroxypropyl, 2-, 3- or 4-hydroxybutyl esters, of these acids.

It is also possible to prepare water-containing 1K polyurethane coating materials by dispersing the blocked polyisocyanates of the invention, with or without solvent, and together with a hydrophilically modified hydroxyl-containing polymer, in water and adding the compounds of the optional components c)-d).

The equivalent ratio of NCO reactive groups from b) to blocked and non-blocked NCO groups from a) is preferably between 0.5 and 3, more preferably from 1.0 to 2.0 and with particular preference from 1.0 to 1.5.

It is possible if desired to use further compounds, reactive with NCO-reactive groups, as an additional crosslinker component in conjunction with the compositions of the invention. Examples of these compounds are compounds containing epoxide groups and/or amino resins. Resins regarded as being amino resins are the condensation products of melamine and formaldehyde or of urea and formaldehyde that are known in paint technology. Suitable condensates include all conventional melamine-formaldehyde condensates which are not etherified or are etherified with saturated monoalcohols having 1 to 4 carbon atoms. Where other crosslinker components are used it is necessary to adapt accordingly the amount of binder containing NCO-reactive groups.

For the application of the 1K polyurethane coating materials of the invention it is possible to employ the techniques customary per se, such as knife coating, dipping, spray applications such as compressed-air spraying or airless spraying, and also electrostatic application, one example being high-speed rotating bell application.

The substrates to be coated may already have been coated with other coating films, so that coating with the coating material comprising the composition of the invention applies a further coating film. The dry film coat thickness can in this case be for example from 10 to 120 μm.

Curing of the dried films is accomplished by baking in temperature ranges from 90 to 160° C., preferably 110 to 140° C.

The 1K polyurethane coating materials of the invention can also be used for continuous coil coating, in which case maximum baking temperatures, known to the person skilled in the art as peak metal temperatures, of between 130 and 300° C., preferably 190 to 260° C., and dry film coat thicknesses of 3 to 40 μm, for example, may be reached.

Substrates suitable for coating with the 1K polyurethane coating materials of the invention include for example metals, woods, composites or plastics of all kinds.

### EXAMPLES

In the examples which follow all percentages, unless stated otherwise, are % by weight.

The NCO content was determined by titration in accordance with DIN EN ISO 11909 (titration with dibutylamine).

The viscosities were measured in accordance with DIN EN ISO 3219 using a VT 500 rotational viscosimeter from Thermo Haake, Karlsruhe, DE at 23° C.

The free monomer contents were determined in accordance with DIN 55956 by GC measurements with a 6890 gas chromatograph from Agilent Technologies, Palo Alto, USA, with an FID detector and a DB 17 column (15 metres length, 0.32 mm internal diameter, 0.5 micrometer film thickness). Solids content and BNCO content are calculated variables, whose calculation is as follows:
Solids content in %=[(total weight−total weight of solvents) divided by total weight] multiplied by 100
BNCO content in %=[(eq blocked NCO groups multiplied by 42) divided by total weight] multiplied by 100
Equivalent % biuret=(number of biuret groups in mol) divided by (number of blocked and/or non-blocked NCO groups in mol) multiplied by 100
   Polyisocyanate 1

Polyisocyanate based on HDI and containing isocyanurate groups, having an NCO content (based on NCO, molecular weight=42) of 21.7% by weight, an average isocyanate functionality of 3.4 (by GPC) and a monomeric HDI content of 0.1%. Viscosity at room temperature 3000 mPas.

Polyisocyanate 2

Polyisocyanate based on HDI and containing iminooxadiazinedione groups, having an NCO content (based on NCO, molecular weight=42) of 23.2% by weight, an average isocyanate functionality of 3.3 (by GPC) and a monomeric HDI content of 0.1%, prepared in accordance with EP-A 798299. Viscosity 700 mPas/23° C.

Polyisocyanate 3

A 6-four-necked flask with contact thermometer, stirrer and reflux condenser was charged with 5040 g (60 eq) of hexamethylene diisocyanate (HDI) at 90° C. 73.8 g (4.1 mol) of distilled water and 183.0 g (1.8 mol) of melted pivalic acid were added dropwise synchronously over the course of 70 minutes from two separate dropping funnels, with thorough stirring. A short time after the beginning of dropwise addition a steady evolution of carbon dioxide began; after the end of the addition measurement with a gas meter showed a corrected result of 85.1 l (76% of theory). After 30 minutes of subsequent stirring at 100° C. and an additional 60 minutes at 120° C., 109 l of carbon dioxide (corrected, 97% of theory) and an NCO content of 37.1% were measured. The solution was filtered and monomeric hexamethylene diisocyanate was removed by thin-film distillation. This gave 2050 g of a polyisocyanate containing 4.1 mol of biuret groups.

| NCO content | 22.5% (10.98 eq) |
|---|---|
| Viscosity at 23° C. | 8000 mPas |
| Monomeric HDI content | 0.15% |
| Equivalent % biuret | 37.3% |

### Example 1 (Inventive)

Polyisocyanate containing biuret groups, diisopropylamine-blocked 101.0 g (1.00 eq) of diisopropylamine were added under dry nitrogen and with stirring to 186.7 g (1.00 eq) of polyisocyanate 3 in 77.5 g of methoxypropyl acetate (MPA), in the course of which addition a slight exotherm was observed. The batch was stirred at 60° C. for 30 minutes and then cooled to room temperature and 77.5 g of isobutanol were added. This gives 426.3 g of a clear, colourless product having the following characteristics:

| Viscosity at 23° C.: | 5700 mPas |
|---|---|
| Equivalent % biuret: | 37.3% |
| Blocked NCO group content | 9.9% (1.00 eq BNCO) |
| (M = 42): | |
| Solids content: | 65% |

After storage of the product for 3 months at room temperature neither clouding of the solution nor any kind of solids precipitation or crystallization was observed.

### Example 2 (Inventive)

Polyisocyanate containing biuret and isocyanurate groups, diisopropylamine-blocked

A 1000 mL three-necked flask with thermometer, reflux condenser and stirrer was charged with 200.0 g (1.04 eq) of polyisocyanate 1, 0.1 g of dibutyl phosphate, 1.14 g of deionized water (0.06 mol, 0.18 eq) and 51 g of butyl acetate and this initial charge was heated under nitrogen to 140° C. After 10 hours of stirring at this temperature an NCO content of 14.5% was reached, corresponding to complete reaction of the water with NCO groups to form amino groups and to the further reaction of the amino groups with in each case two NCO groups to form biuret groups. The product was cooled to 40° C. and diluted with 25.5 g of butyl acetate. Then 86.5 g (0.86 eq) of diisopropylamine were added to the product, in the course of which addition a slight exotherm was observed. The batch was stirred at 60° C. for 30 minutes and then cooled to room temperature and 75.5 g of isobutanol were added. Subsequently, free isocyanate groups were no longer detectable in the IR spectrum. This gives 437.1 g of a clear, colourless product having the following characteristics:

| Viscosity at 23° C.: | 5700 mPas |
|---|---|
| Equivalent % biuret: | 7.0% |
| Blocked NCO group content | 8.1% (0.82 eq BNCO) |
| (M = 42): | |
| Solids content: | 64.8% |

After storage of the product for 3 months at room temperature neither clouding of the solution nor any kind of solids precipitation or crystallization was observed.

### Example 3 (Comparative)

Polyisocyanate containing isocyanurate groups, diisopropylamine-blocked 193.5 g of polyisocyanate 1 were diluted with 79.3 g of methoxypropyl acetate (MPA) and 101.0 g of diisopropylamine were added under dry nitrogen and with stirring, during which addition a slight exotherm was observed. Following complete addition, the mixture was heated to 70° C. and after 30 minutes of stirring at that temperature the batch was cooled to room temperature. Subsequently, free isocyanate groups were no longer detectable in the IR spectrum. Finally the product was diluted with a further 79.3 g of isobutanol to give a clear, almost colourless product having the following characteristics.

| Viscosity at 23° C.: | 2070 mPas |
|---|---|
| Blocked NCO group content | 9.3% |
| (molecular weight = 42): | |
| Solids content: | 65% |

After 14 days of storage at room temperature solidification, through crystallization, began. After 18 days of storage at room temperature a solid white opaque mass had formed.

### Example 4 (Inventive)

Polyisocyanate containing biuret and iminooxadiazinedione groups, diisopropylamine-blocked

A 1000 mL three-necked flask with thermometer, reflux condenser and stirrer was charged with 200.0 g of polyisocyanate 2 (1.10 eq), 0.1 g of dibutyl phosphate, 1.14 g of deionized water (0.06 mol, 0.18 eq) and 51.5 g of butyl acetate and this initial charge was heated under nitrogen to 140° C. After 10 hours of stirring at this temperature an NCO content of 14.5% was reached, corresponding to complete reaction of the water with NCO groups to form amino groups and to the further reaction of the amino groups with in each case two NCO groups to form biuret groups. The product was cooled to 40° C. and diluted with 27 g of butyl acetate. Then 93.4 g (0.93 eq) of diisopropylamine were added to the product, in the course of which addition a slight exotherm was observed. The batch was stirred at 60° C. for 30 minutes and then cooled to room temperature and 78 g of isobutanol were added. Subsequently, free isocyanate groups were no longer detectable in the IR spectrum. This gives 448.5 g of a clear, colourless product having the following characteristics:

| Viscosity at 23° C.: | 5700 mPas |
|---|---|
| Equivalent % biuret: | 6.5 |
| Blocked NCO group content | 8.6% (0.92 eq BNCO) |
| (M = 42): | |
| Solids content: | 65% |

After storage of the product for 3 months at room temperature neither clouding of the solution nor any kind of solids precipitation or crystallization was observed.

### Example 5 (Comparative)

Polyisocyanate containing iminooxadiazinetrione groups, diisopropylamine-blocked

181.0 g of polyisocyanate 2 were diluted with 76.0 g of methoxypropyl acetate (MPA) and 101.0 g of diisopropylamine were added under dry nitrogen and with stirring, during which addition a slight exotherm was observed. Following complete addition, the mixture was heated to 70° C. and after 30 minutes of stirring at that temperature the batch was cooled to room temperature. After this time, free isocyanate groups were no longer detectable in the IR spectrum. Subsequently the product was diluted with a further 76.0 g of isobutanol to give a clear, almost colourless product having the following characteristics.

| Viscosity at 23° C.: | 1560 mPas |
|---|---|
| Blocked NCO group content | 9.7% |
| (molecular weight = 42): | |
| Solids content: | 65% |

After 14 days of storage at room temperature solidification, through crystallization, began. After 18 days of storage at room temperature a solid white opaque mass had formed.

While the blocked polyisocyanates mentioned in Comparative Examples 3 and 5 crystallize from the organic solutions after short storage, the blocked polyisocyanates of the invention from Examples 1, 2 and 4 show no signs of any crystallization for more than 3 months.

### Example 6 (Comparative)

Polyisocyanate containing biuret and isocyanurate groups, diisopropylamine-blocked, based on a polyisocyanate according to WO 03/025040

A 1000 mL three-necked flask with thermometer, reflux condenser and stirrer was charged with 200.0 g (1.04 eq) of polyisocyanate 1, 0.1 g of dibutyl phosphate, 0.54 g of deionized water (0.03 mol, 0.09 eq) and 50.0 g of butyl acetate and this initial charge was heated under nitrogen to 140° C. After 10 hours of stirring at this temperature an NCO content of 15.9% was reached, corresponding to complete reaction of the water with NCO groups to form amino groups and to the further reaction of the amino groups with in each case two NCO groups to form biuret groups. The product was cooled to 40° C. and diluted with 30.0 g of butyl acetate. Then 96.0 g (0.95 eq) of diisopropylamine were added to the product, in the course of which addition a slight exotherm was observed. The batch was stirred at 60° C. for 30 minutes and then cooled to room temperature and 80 g of isobutanol were added. Subsequently, free isocyanate groups were no longer detectable in the IR spectrum. This gives 455.4 g of a clear, colourless product having the following characteristics:

| Viscosity at 23° C.: | 3700 mPas |
|---|---|
| Equivalent % biuret: | 3.1% |
| Blocked NCO group content | 8.7% (0.82 eq BNCO) |
| (M = 42): | |
| Solids content: | 64.9% |

After 2 months of storage at room temperature solidification, through crystallization, began. After 3 months of storage at room temperature a solid white opaque mass had formed.

### Example 7

Preparation and testing of the properties of coating materials based on some of the polyisocyanates described in the examples (inventive and comparative)

Based on the blocked polyisocyanate from Example 1 and the hydroxy-functional polyester polyol Desmophen® T 1665 from Bayer A G Leverkusen, DE (hydroxyl content, solvent-free according to DIN 53 240/2 approximately 2.6%, 65% in . Solvent naphtha 100/isobutanol 31.5:3.5, equivalent weight 1000), a realistic coil coating material was prepared. Also used were the white pigment Tronox R-KB-4 from Kerr-McGee, Krefeld-Uerdingen, DE and, as further additives, cellulose acetobutyrate CAB 531-1 from Krahn Chemie GmbH, Hamburg, DE dibutyltin dilaurate from Brenntag, Mühlheim/Ruhr, DE Acronal® 4 F from BASF AG, Ludwigshafen, DE and as solvent Solvesso® 200 S from Deutsche Exxon, Cologne, DE.

The coating materials were formulated so that the ratio of hydroxyl groups of the polyester to the blocked NCO groups of polyisocyanate was 1:1 and the ratio of the nonvolatile constituents of the polyisocyanate and of the polyester to the pigment was 1:1. The coating materials, based on the fraction of the nonvolatile constituents of the polyisocyanate and of the polyester, contained 0.3% by weight dibutyltin dilaurate, 1.2% by weight CAB 531-1 and 0.3% Acronal® 4 F. The application viscosity was adjusted to a level of approximately 100 s (DIN EN ISO 2431, cup with 5 mm nozzle/23° C.) by dilution with Solvesso® 200 S. The coating materials were still homogeneous after 3 months of storage at room temperature.

The coating materials were applied by knife-coating to a chromated aluminium panel and were baked in a coil coating oven from Aalborg at 350° C. in each case until the peak metal temperatures indicated in Table 1 were reached.

As the test results on the coating materials from Table 1 show it is possible to prepare 1K polyurethane coating materials suitable for coil coating using the blocked polyisocyanates of the invention.

TABLE 1
Test results on the coating materials

| | I | II |
|---|---|---|
| Coating materials | inventive | inventive |
| Film thickness [μm] | 21 | 20 |
| [ECCA T1] (*1) | | |
| Gardner gloss | 42/76 | 58/75 |
| at 20°/60° [ECCA-T2] (*1) | | |
| Berger whiteness | 85.4 | 90.5 |
| (at PMT 254° C.) (*2) | | |
| MEK wipe test (*3) at PMT | 75 | 60 |
| 199° C. | | |
| MEK wipe test at PMT 204° C. | >100 | >100 |
| MEK wipe test at PMT 210° C. | >100 | >100 |
| MEK wipe test at PMT 216° C. | >100 | >100 |
| Microhardness (*4) penetration | 99.4 | 45.5 |
| depth [μm] HU corr. N/mm² | | |
| Erichsen cupping | GT 0 | GT 0 |
| cross-hatch [6 mm] | | |
| [ECCA-T6] (*1) | | |

(*1) Standards of the European Coil Coating Association
(*2) Measured with instrument of the type color-guide sphere from the manufacturer Byk Gardner on the CIE-L*a*b* scale
(*3) Double rubs with a cotton pad soaked with methyl ethyl ketone (MEK) under an applied pressure of about 2 kg; number until the coating film softens
(*4) Measured with instrument Fischerscope H100 SMC from Fischer, DE

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for preparing blocked polyisocyanates, comprising
A) reacting one or more polyisocyanates with
B) one or more biuretizing agents and
C) optionally, catalysts such that in the blocked end product there are 5-45 equivalent% of biuret groups of the formula (I) 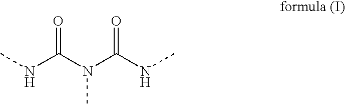
based on the sum total of all free and blocked NCO groups,
D) optionally, modifying the resulting biuret polyisocyanates with the aid of isocyanate-reactive compounds and/or catalysts, with further reaction of free NCO groups, and subsequently
E) blocking at least 95 mol % of the remaining free NCO groups with a blocking agent of the formula R¹R²NH, in which R¹ and R² independently of one another are aliphatic or cycloaliphatic C ₁-C ₁₂ alkyl radicals.

2. The process for preparing blocked polyisocyanates according to claim 1,
wherein the polyisocyanates used in A) are based on hexamethylene diisocyanate.

3. The process for preparing blocked polyisocyanates according to claim 1,
wherein water is used as biuretizing agent.

4. The process for preparing blocked polyisocyanates according to claims 1,
wherein diisopropylamine is used as blocking agent.

5. Blocked polyisocyanates obtained by the process according to claim 1.

6. Coating compositions produced by combining the blocked polyisocyanates according to claim 5 and one or more NCO-reactive binders containing on average at least two isocyanate-reactive groups per molecule.

7. One-component baking systems comprising
a) one or more blocked polyisocyanates according to claim 5,
b) one or more NCO-reactive binders containing on average at least two isocyanate-reactive groups per molecule,
c) optionally catalysts and
d) optionally solvents, auxiliaries and additives.

8. Coatings obtained by combining the blocked polyisocyanates according to claim 5 and dihydroxyl compounds and/or polyhydroxyl compounds.

9. Substrates coated with coatings according to claim 8.

10. The process for preparing blocked polyisocyanates according to claim 2,
wherein water is used as biuretizing agent.

11. The process for preparing blocked polyisocyanates according to claims 2,
wherein diisopropylamine is used as blocking agent.

12. The process for preparing blocked polyisocyanates according to claims 3,
wherein diisopropylamine is used as blocking agent.

13. Blocked polyisocyanates obtained by the process according to claim 2.

14. Blocked polyisocyanates obtained by the process according to claim 3.

15. Blocked polyisocyanates obtained by the process according to claim 4.

16. Polyurethane polymers produced by reacting the blocked polyisocyanates according to claim 5 and one or more NCO-reactive binders containing on average at least two isocyanate-reactive groups per molecule.

17. Polyurethane polymers obtained by reacting the blocked polyisocyanates according to claim 5 and dihydroxyl compounds and/or polyhydroxyl compounds.

18. Substrates coated with coatings according to claim 6.
